(19) United States
(12) Patent Application Publication
(10) Pub. No.: US 2008/0301951 A1
(43) Pub. Date: Dec. 11, 2008

(54) HIDDEN SWITCH LOCATING MEANS FOR A GARDENING TOOL

(76) Inventor: Hung-Chou LAI, Wuri Shiang (TW)

Correspondence Address: RABIN & BERDO, P.C., Suite 500, 1101 14th Street, N.W., Washington, DC, 20005, US

(21) Appl. No.: 11/758,105

(22) Filed: Jun. 5, 2007

(51) Int. Cl. B26B 13/00

(52) U.S. Cl. 30/254

(57) ABSTRACT

A hidden switch locating means for a gardening tool includes a pair of blades pivoted to each other, each blade containing a cutting edge and a handle; each handle being provided with a pivoting base containing a pivoting hole and multiple arc holes of different diameters and being blocked by a cap; a pivoting bolt penetrating both pivoting holes and locked up with a nut; both caps being linked to each other with multiple keys and key troughs disposed to both caps; multiple arc holes from both pivoting portions being in a relation of alternatively deflected asymmetry with both blades stretched out, and in a fully penetrating relation with both blades closing upon each other; and limitation and release of stretching and clamping of both blades being controlled by pressing both caps to change relation between keys and arc holes.

### FIELD OF THE INVENTION

The present invention relates to a hidden switch locating means for a gardening tool, and more particularly to a structure that is adapted to a pair of pruning shears by providing holes of different diameters in a pivoting portion of two blades designed in conjunction with two sections of rod diameter of multiple keys filled between two caps respectively disposed outside two handles so to change relative positions among keys and holes of different diameters by moving both caps to limit or release stretching and clamping functions of both blades to become a locating means for the gardening tool when closed for storage.

### BACKGROUND OF THE INVENTION

It is known that a pair of pruning shears is usually used to trim branches and leaves to maintain nice and neat appearance of a garden. The pruning shears and similar gardening tools are generally each comprised of two blades crossly overlapped and pivoted to each other; each blade has its front section functioning as a cutting portion and its rear section extended to form a handle covered up with a rubber/plastic material; and a coil is separately held between two handles at where closer to a pivot portion of both blades so to provide return force to control the pair of shears for pruning.

The blade of a pair of pruning shears must be made sharp on its edge and point at its tip to serve its purpose. However, when it is stored when not in use and both blades have not been properly closed upon each other; a user may get cut by the edge or point of the blade when fetching it for use next time. To solve the problem, a buckling means is usually provided to lock up both blades of the pair of pruning shears in their closed status for storage and use safety.

However, the buckling means presents other problems. Improperly located buckling means or getting too small in size makes it is difficult to operate and even affects control of the shearing operation. The buckling means could accidentally lock up both blades due to improper operation by its user, and the user just has to repeatedly release the buckling means to interrupt the work. Therefore, an addition of the buckling means not only discounts the appearance of the pruning pairs but also presents many problems and disadvantages in terms of convenient use of the pruning shears as a whole.

### SUMMARY OF THE INVENTION

The primary purpose of the present invention is to provide a hidden switch locating means for a garden tool that operates by pressing to facilitate control of closing and releasing both blades of the gardening tool.

Another object of the present invention is to provide a hidden switch locating means for a garden tool that secures the gardening tool in position when stored without exposing to get loosened up.

Another object of the present invention is to provide a hidden switch locating means for a garden tool that achieves its purpose of securing the gardening tool in position without compromise the general appearance of the gardening tool.

Another object of the present invention is to provide a hidden switch locating means for a gardening tool that its existence does not affect normal operation of the gardening tool.

To achieve the above and other objects, multiple arc holes of different diameters are respectively disposed on a pivoting portion of each blade in conjunction of two sections of rod diameters designed for multiple keys filled between two caps respectively disposed to an outer side of both handles to execute limit and release functions of stretching and clamping both blades for securing the gardening tool in place when not used.

### BRIEF DESCRIPTION OF THE DRAWINGS

FIG. 1 is an exploded view showing a construction of a preferred embodiment of the present invention;

FIG. 2 is a schematic view showing the construction of the preferred embodiment of the present invention when assembled;

FIG. 3 is a schematic view showing a constructional relation of the preferred embodiment of the present invention in a status of having both blades been closed upon each other;

FIG. 4 is a schematic view showing a constructional relation of the preferred embodiment of the present invention in a status of having both blades been stretched out from each other;

FIG. 5 is a schematic view showing at another view direction a locally constructional relation of the preferred embodiment in a status of having both blades been closed upon from each other; and

FIG. 6 is a schematic view showing at another view direction a locally constructional relation of the preferred embodiment in a status of having both blades been stretched out from each other.

### DETAILED DESCRIPTION OF THE PREFERRED EMBODIMENTS

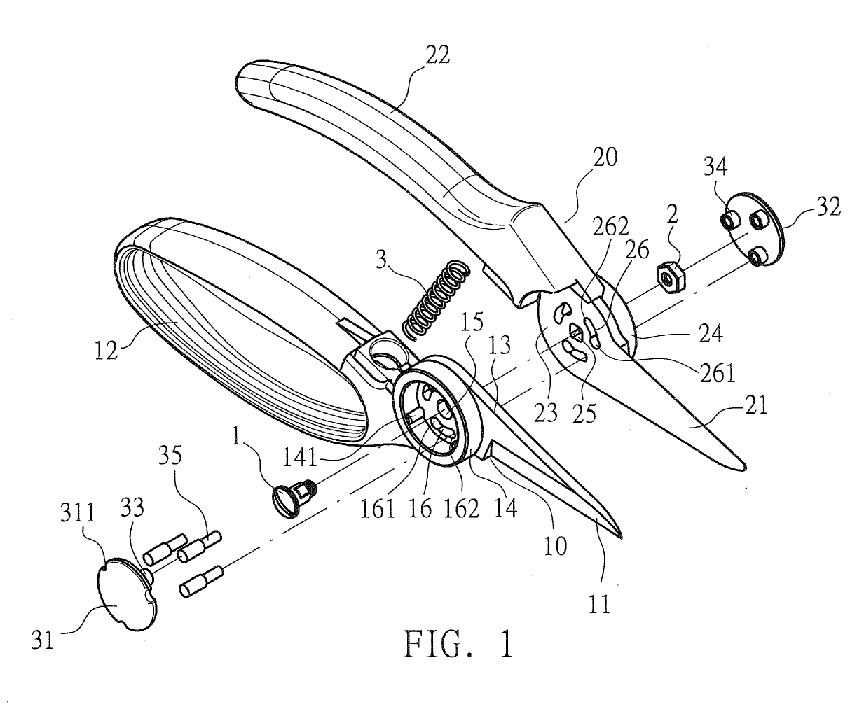

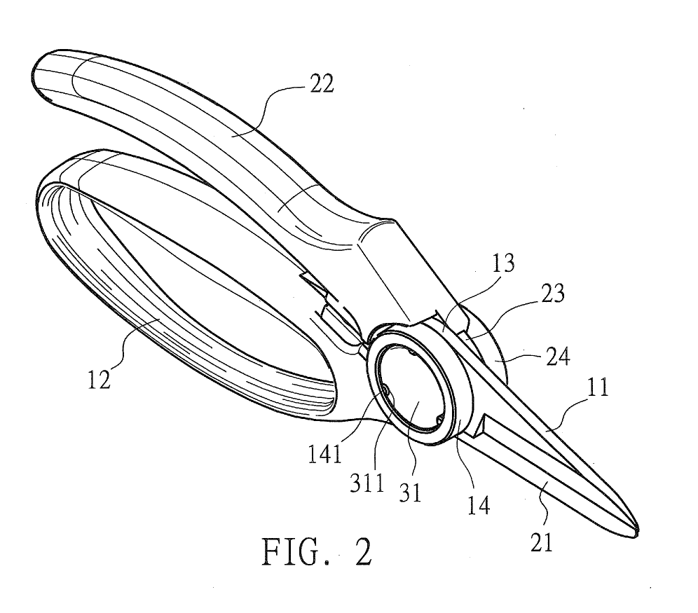

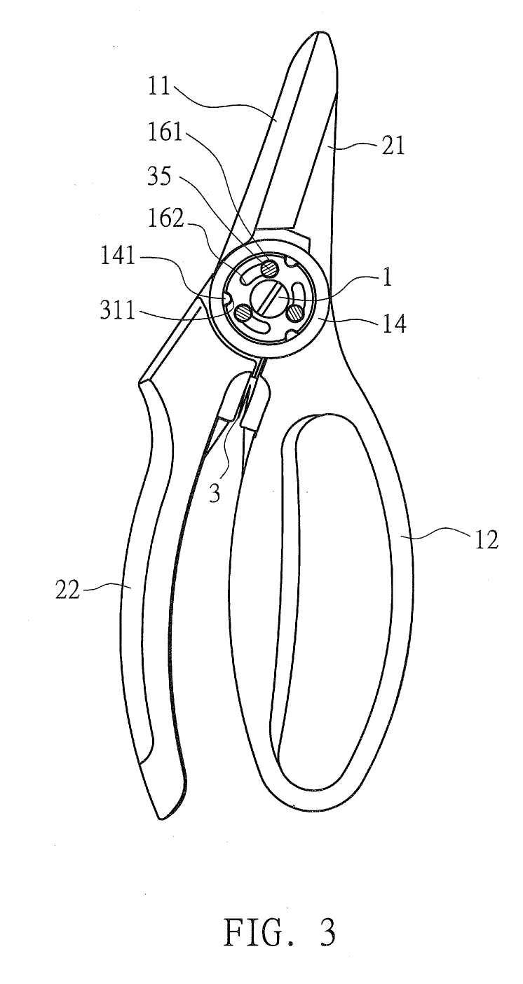

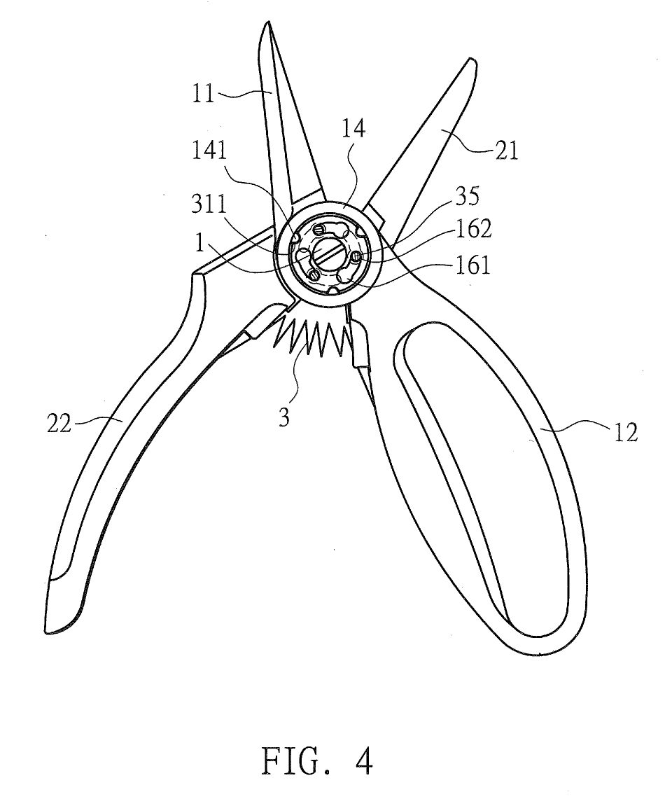

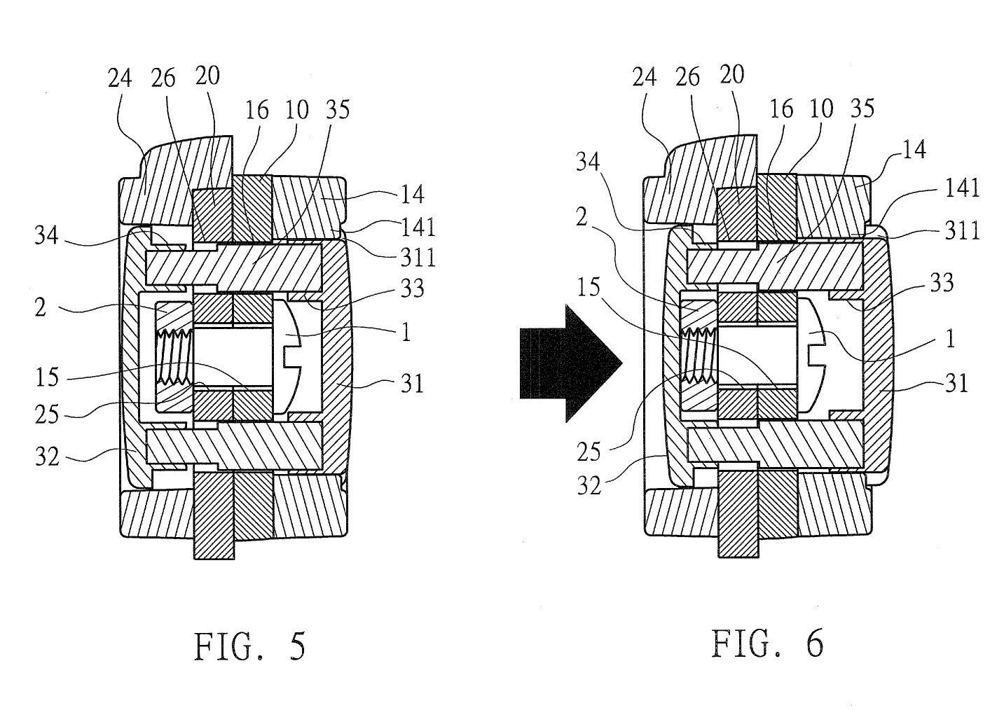

Referring to FIGS. 1 through 6, a preferred embodiment of the present invention is essentially comprised of two blades (10) (20) crossing each other and pivoted to each other by means of a locking bolt (1) and a nut (2) to form a basic construction of a pair of pruning shears; a front section of each blade (10) (20) is made into a cutting edge (11) (21); and a rear section of each blade (10) (20) extends for and covered up with a rubber/plastic material to form a handle (12) (22); and a coil (3) is mounted between two handles (12) (22) at two approximate ends respectively of both handles (12) (22) to where both blades (10) (20) are pivoted to each other. Accordingly, pressing and releasing both handles (12) (22) in conjunction with the return force from the coil (3) control stretching and clamping of both cutting edges (11) (21) to provide a configuration of a basic function of a gardening tool similar to the pair of pruning shears.

In the present invention, a portion where both blades (10) (20) are pivoted to each other is made into a large disk type of pivoting portion (13) (23) for each blade (10) (20); a pivoting base (14) (24) extends from the pivoting portion (13) (23) to an outer side of the handle (12) (22) disposed at the rear section of the blade (10) (20); the pivoting base (14) (24) is sealed with a cap (31) (32); a pivoting hole (15) (25) is disposed at a center of the pivoting portion (13) (23) of the blade (10) (20); and both blades (10) (20) are pivoted to each other with the locking bolt (1) and the nut (2). Meanwhile, multiple pairs of arc holes (16) (26) in different diameters are disposed surrounding the pivoting hole (15) (25) at the pivoting portion (13) (23) of the blade (10) (20); each arc hole (16) (26) has one larger diameter hole section (161) (261) and another smaller diameter hole section (162) (262).

Those multiple arc holes (16) of different diameters provided on the blade (10) and those multiple arc holes (26) provided on the handle (20) indicate alternatively deflected asymmetry fashion when both blades (10) (20) are stretched out from each other; and will indicate a relation of fully penetrating through each other only when both blades (10) (20) are closed upon each other. Multiple key troughs (33) (34) in a pre-designated number are respectively disposed on an inner edge of the cap (31) (32) in the pivoting base (14) (24) extending from the handle (12) (22) of the blade (10) (20); and a key (35) containing a larger rod diameter section and a smaller rod diameter section passing through those arc holes (16) (26) has both rod diameters sections respectively inserted and incorporated into both key troughs (33) (34) to link both caps (31) (32) to each other. The larger rod diameter section of each key (35) merely passes through the larger diameter holes sections (161) (261) of the arc holes (16) (26) and the smaller rod diameter section of the key (35) merely passes through the smaller diameter hole sections (162) (262) of the arc holes (16) (26).

Accordingly, a relation between those keys (35) and those arc holes (16) (26) can be changed by pressing both caps (31) (32) when both blades (10) (20) are closed upon each other so to limit and release functions of stretching and clamping executed by both blades (10) (20). To achieve stable operation of pressing both caps (31) (32), multiple protruding posts (141) are erected on an inner wall on one side of the pivoting base (14) and multiple gaps (311) corresponding to those protruding posts (141) are provided on a circumference of the cap (31) so to facilitate assembly the cap (31) to the pivoting base (14) while providing proper guidance and retaining in the control of the operation of pressing the caps (31) (32) and prevent both caps (31) (32) from rotating, thus to maintain accurate and stable relation between both blades (10) (20). Based on the relation, the locating means of the present invention is created.

According to the locating means disclosed above, the cap (31) can be easily pressed to allow the larger rod diameter section of each key (35) to pass through both larger diameter hole sections (161) (261) of both arc holes (16) (26) since each pair of arc holes (16) (26) of both pivoting portions (13) (23) indicate the correspondingly penetrating through fashion when both blades (10) (20) are closing upon each other. Consequently, limitation by those keys (35) preventing both blades (10) (20) from being pushed against by elasticity of the coil (3) to realize separation from each other by pivoting and stretching out maintains both blades (10) (20) in their status of closing upon each other to achieve the purpose of keeping the gardening tool in position.

When use of the gardening tool is desired, press the cap (32) and push counter-clockwise to move the smaller rod diameter section of each key (35) into the larger diameter hole sections (161) (261) of both arc holes (16) (26) so to release both blades (10) (20) from being secured to each other. Therefore, both blades (10) (20) are stretched out as pushed against by the coil (3) and enabled to execute free stretch out and clamping movements in providing normal pruning purpose. Furthermore, both pivoting bases (14) (24) and both caps (31) (32) applied in the present invention to control locating and releasing functions of the gardening tool in a status of having both blades closing upon each other are integrated to both pivoting portions (13) (23) of two blades (10) (20). Under this type of constructional relation, the pivoting bolt (1) that pivots both blades (10) (20) and the nut (2) are hidden in the locating means so to improve the general appearance of the gardening tool while effectively preventing the pivoting bolt (1) and the nut (2) from developing rust. Meanwhile, the locating means is provided at the pivoting portions (13) (23), its presence will not affect normal operation of the gardening tool and will prevent it from accidental lockup whenever touched in the course of pruning as found with the prior art.

Therefore, the present invention by having an integrated locating means of a gardening tool disposed to a portion where both blades (10) (20) of the gardening tool are pivoted to each other and by allowing easy press control of locating and releasing both blades (10) (20) so to firmly secure both blades in position without affecting appearance of the gardening significantly upgrades the sense of the general quality of the gardening tool.

Accordingly, the present invention realizes securing both blades of a gardening tool in position when stored by directly pressing both caps contained in pivoting bases disposed on both sides of a pivot in conjunction with multiple arc holes of different diameters prefabricated to the pivot to change relation between multiple keys with each made in two sections of different diameters, thus to achieve locating and releasing efficacy of the gardening tool in its stored status. In general, the present invention provides excellent industrial applicability and utility; and this application for a patent is duly filed.

What is claimed is:

1. A hidden switch locating means for a gardening tool including the gardening tool containing two blades pivoted to each other with a pivoting bolt and a nut; each blade containing a cutting edge at its front section and a handle extending from the cutting edge and covered up with a rubber or plastic material at the rear section of the blade; a coil being disposed between two handles at where closer to a pivoting portion that holds both blades together; both handles being pressed in to control stretching out and clamping to cut in conjunction with a return force from the coil; the pivoting portion for both blades of the gardening tool being related to an enlarged disk portion; a pivoting base extending from the pivoting portion outside the handle at the read end of each blade; each pivoting base being blocked by a cap; multiple pairs of arc holes of different diameters surrounding a peripheral of a pivoting hole disposed at the center of the pivoting portion of both blades; the pivoting hole receiving the pivoting bolt to the pivoting portion with a nut; each arc hole being provided with a larger diameter hole section on one end and a smaller diameter hole section on the other end; those multiple arc holes of different diameters being in a alternatively deflected relation with both blades being stretched out; those multiple arc holes of different diameters being in a fully penetrating through relation with both blades being closed upon each other; two caps being linked to each other for operation by having multiple keys inserted and incorporated with both caps; each key containing a larger diameter rod section and a smaller diameter rod section to respectively penetrate through the larger and the smaller diameter hole sections of the arc hole; the relation between those multiple keys and those multiple arc holes of different diameters being changed by pressing to move either cap to limit or release stretching and clamping of both blades; and both blades being stored by firmly closing upon each other.

2. The hidden switch locating means for a gardening tool as claimed in claim 1, wherein each cap filled in a pivoting base extending from each handle of the gardening tool is provided on its inner side multiple key troughs in a pre-designated number; and each key trough receives insertion and incorporation from the key passing through the arc holes of different diameters; and both caps are linked to each other for operating the locating means.

3. The hidden switch locating means for a gardening tool as claimed in claim 1, wherein, multiple protruding posts are erected on an inner wall of the pivoting base on one handle; and multiple corresponding gaps are disposed on circumference of the cap.
